(19) United States
(12) Patent Application Publication
(10) Pub. No.: US 2025/0153767 A1
(43) Pub. Date: May 15, 2025

(54) CONTROL DEVICE, CONTROL METHOD, AND CONTROL SYSTEM

(71) Applicant: HITACHI ASTEMO, LTD., Hitachinaka-shi, Ibaraki (JP)

(72) Inventors: Huajun LIU, Hitachinaka-shi, lbaraki (JP); Yasuhito NAKAKUKI, Hitachinaka-shi, lbaraki (JP)

(73) Assignee: HITACHI ASTEMO, LTD., Hitachinaka-shi, Ibaraki (JP)

(21) Appl. No.: 18/715,966

(22) PCT Filed: Jan. 19, 2023
(86) PCT No.: PCT/JP2023/001446

§ 371 Date: Dec. 3, 2024

(30) Foreign Application Priority Data
Feb. 2, 2022 (JP) 2022-014650

(51) Int. Cl. B62D 5/04; B62D 6/00

(52) U.S. Cl. CPC B62D 5/0469; B62D 5/0448; B62D 5/0472; B62D 6/008; B62D 5/0424

(57) ABSTRACT

A control device, a control method, and a control system according to the present invention perform damping control of buffering movement of a movable member immediately before the movable member abuts on a stopper portion, and when a moving speed of the movable member satisfies a predetermined condition, output a control signal for suppressing a speed of the movable member before the damping control is performed. As a result, in a steering mechanism that includes a motor applying torque to a movable member relating to steering, and a stopper mechanism including a stopper portion that can abut on the movable member and limiting a moving range of the movable member, impact force when the movable member abuts on the stopper portion can be reliably reduced.

### TECHNICAL FIELD

The present invention relates to control devices, control methods, and control systems.

### BACKGROUND ART

When a turning angle is in a vicinity of a rack end, and a steering wheel is operated for steering in a turning direction, a power steering apparatus disclosed in Patent Document 1 calculates a damping signal to be increased as steering velocity increases. In addition, when the turning angle is in the vicinity of the rack end, and the steering wheel is operated for steering in the turning direction, the power steering apparatus performs limit processing so as to maintain or reduce a basic assist command signal in the turning direction.

### REFERENCE DOCUMENT LIST

### PATENT DOCUMENT

Patent Document 1: JP 2015-174565

### SUMMARY OF THE INVENTION

### Problem to be Solved by the Invention

When damping control for generating motor torque for decelerating a movable member relating to steering in a steering mechanism is performed immediately before the movable member abuts on a stopper portion of a stopper mechanism, impact force when the movable member abuts on the stopper portion can be reduced.

However, in a case in which a moving speed of the movable member is high, required torque in the damping control may not be generated because the required torque exceeds limit torque corresponding to a motor rotation speed [rpm].

When the required torque in the damping control cannot be generated, the deceleration speed of the movable member is insufficient, and the effect of reducing the impact force is accordingly less.

The present invention has been made in consideration of the existing circumstances, and an object of the present invention is to provide a control device, a control method, and a control system that can reliably reduce impact force when the movable member abuts on the stopper portion.

### Means for Solving the Problem

According to the present invention, in one aspect, a control device, a control method, and a control system perform damping control of buffering movement of a movable member immediately before the movable member abuts on a stopper portion, and when a moving speed of the movable member satisfies a predetermined condition, output a control signal for suppressing a speed of the movable member before the damping control is performed.

### Effects of the Invention

According to the present invention, it is possible to reliably reduce impact force when the movable member abuts on the stopper portion.

### BRIEF DESCRIPTION OF THE DRAWINGS

FIG. 1 is a schematic view illustrating an electric power steering apparatus.

FIG. 2 is a cross-sectional view illustrating a stopper mechanism for a rack bar.

FIG. 3 is a cross-sectional view illustrating a transmission mechanism transmitting rotational force of a motor to the rack bar.

FIG. 4 is a functional block diagram illustrating a first embodiment of setting control of command torque.

FIG. 5 is a graph illustrating correlation between a steering angular velocity and upper/lower limit values.

FIG. 6 is a functional block diagram illustrating a second embodiment of the setting control of the command torque.

FIG. 7 is a functional block diagram illustrating a third embodiment of the setting control of the command torque.

FIG. 8 is a schematic configuration diagram of a steer-by-wire steering system.

FIG. 9 is a functional block diagram illustrating a fourth embodiment of the setting control of the command torque.

FIG. 10 is an exploded perspective view illustrating a stopper mechanism for a steering shaft.

FIG. 11 is a functional block diagram illustrating a fifth embodiment of the setting control of the command torque.

FIG. 12 is a functional block diagram illustrating a sixth embodiment of the setting control of the command torque.

### MODE FOR CARRYING OUT THE INVENTION

Embodiments of a control device, a control method, and a control system according to the present invention are described below with reference to the drawings.

### First Embodiment

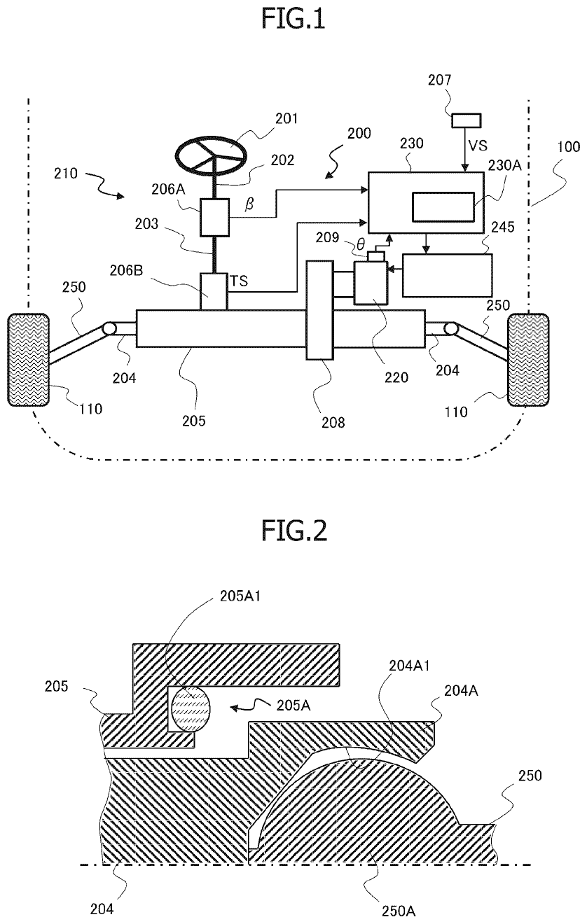

FIG. 1 is a schematic view illustrating an electric power steering apparatus 200 mounted on a vehicle 100 in a first embodiment.

A steering mechanism 210 of electric power steering apparatus 200 includes, as a basic configuration, a steering wheel 201, a steering shaft 202 that is a rotary shaft of steering wheel 201, a pinion shaft 203 provided at an end of steering shaft 202, a rack bar 204, and a rack housing 205 housing rack bar 204.

In steering mechanism 210, when steering wheel 201 is rotationally operated by a driver of vehicle 100, steering torque of steering wheel 201 is transmitted to pinion shaft 203 through steering shaft 202.

When rotating motion of pinion shaft 203 is converted into linear motion of rack bar 204, a turning angle of each of right and left wheels 110 and 110 (more specifically, right and left front wheels) coupled to both ends of rack bar 204 through tie rods 250, is changed.

In other words, the rotating motion of steering shaft 202 is converted into the linear motion of rack bar 204 as a steering operation, by a rack and pinion system using engagement of pinion shaft 203 and rack teeth provided on rack bar 204.

A steering angle sensor 206A that detects a steering angle β as a rotation angle of steering shaft 202, and a steering torque sensor 206B that detects steering torque TS of steering wheel 201, are provided on steering shaft 202.

The steering angle β detected by steering angle sensor 206A is a physical quantity relating to an operation quantity of steering wheel 201.

Steering angle sensor 206A detects the steering angle β as 0 [deg] when steering wheel 201 is at a neutral position, and distinguishes steering directions from the neutral position by positive and negative signs.

Steering mechanism 210 further includes a motor 220 that applies torque to rack bar 204 as a movable member relating to steering.

Rotating motion of motor 220 is transmitted to rack bar 204 through a transmission mechanism 208 including a belt and a ball screw.

Application of the steering toque by motor 220 is performed in order to assist steering force of the driver or to perform autonomous steering (i.e., automatic steering).

Motor 220 is a three-phase brushless DC motor including stator coils including a U-phase, a V-phase, and a W-phase, and a motor rotor.

A driving circuit 245 includes a three-phase bridge inverter including six switching elements, and controls power supplied to the stator coils of motor 220 by controlling on and off of the switching elements.

A control device 230 is an electronic control device mainly including a microcomputer 230A as a control unit, and outputs a control signal for driving and controlling motor 220.

Microcomputer 230A acquires a signal relating to the steering angle β output from steering angle sensor 206A, a signal relating to the steering torque TS output from steering torque sensor 206B, a signal relating to a vehicle speed VS output from a vehicle speed sensor 207 (or wheel speed sensor), a signal relating to a rotation angle θ of the rotor of motor 220 output from a motor rotation angle sensor 209, and the like.

Microcomputer 230A determines command torque that is a target value of torque output from motor 220, based on information on the steering torque TS, the vehicle speed VS, the steering angle β, and the like.

Furthermore, microcomputer 230A outputs a switch signal to driving circuit 245 based on the command torque, and performs PWM (Pulse Width Modulation) control of a driving current of motor 220.

FIG. 2 is an enlarged cross-sectional view of an end of cylindrical rack housing 205 housing rack bar 204, and illustrates an aspect of a stopper mechanism for limiting a moving range of rack bar 204 in an axial direction.

Rack ends 204A are fixed to respective ends of rack bar 204.

Rack ends 204A and respective wheels 110 and 110 are coupled by tie rods 250.

Each of rack ends 204A includes a concave portion 204A1 recessed in an arc shape, and a ball-shaped end 250A of corresponding tie rod 250 is fitted into concave portion 204A1.

Concave portion 204A1 and ball-shaped end 250A are combined to configure a ball joint.

Stopper portions 205A that can abut on respective rack ends 204A are provided at respective ends of rack housing 205, and the stopper mechanism limits the moving range of rack bar 204 in the axial direction by abutment of rack ends 204A of rack bar 204 on respective stopper portions 205A.

In other words, rack bar 204 is movable within a range between a position where one rack end 204A abuts on corresponding stopper portion 205A and a position where another rack end 204A abuts on corresponding stopper portion 205A.

In other words, the position where each of rack ends 204A abuts on corresponding stopper portion 205A is a position of rack bar 204 where right and left turning angles of wheels 110 and 110 are maximized.

Note that each of stopper portions 205A includes a buffer member 205A1 reducing collision between stopper portion 205A and corresponding rack end 204A.

Each of buffer members 205A1 is made of an elastic material in an annular shape.

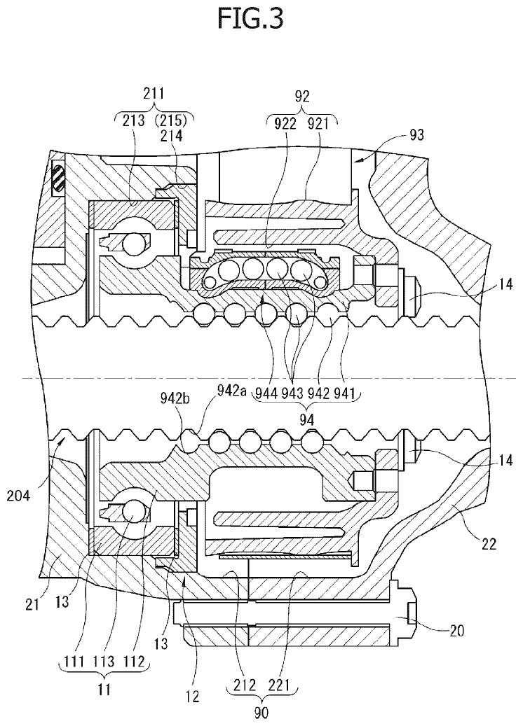

FIG. 3 is an enlarged cross-sectional view illustrating a vicinity of the ball screw of transmission mechanism 208 in an enlarged manner.

Transmission mechanism 208 includes an input-side pulley (not illustrated) on motor 220 side, an output-side pulley 92, a belt 93 wound between the input-side pulley and output-side pulley 92, and a ball screw 94 as a deceleration mechanism that converts rotation of output-side pulley 92 into motion in the axial direction of rack bar 204 while decelerating the rotation of output-side pulley 92.

Output-side pulley 92 is disposed on an outer periphery side of rack bar 204, and is linked with rack bar 204 through ball screw 94.

More specifically, output-side pulley 92 includes an output-side winding portion 921, and is fixed, by a plurality of bolts 14, to a facing end surface of a nut 941 of ball screw 94 received in a concave portion 922 provided on an inner peripheral side.

As a result, output-side pulley 92 is rotated integrally with nut 941 of ball screw 94 around the axis of rack bar 204.

Belt 93 transmits rotational force of the input-side pulley (i.e., motor 220) to output-side pulley 92 by synchronously rotating the input-side pulley and output-side pulley 92.

Rack housing 205 includes a first housing 21 and a second housing 22 that are divided in the axial direction.

First housing 21 and second housing 22 are fastened by a plurality of bolts 20.

First housing 21 includes a deceleration mechanism housing portion 211 housing ball screw 94.

First housing 21 further includes a first transmission mechanism housing portion 212 housing a part of transmission mechanism 208, and second housing 22 includes a second transmission mechanism housing portion 221 housing a part of transmission mechanism 208.

First transmission mechanism housing portion 212 and second transmission mechanism housing portion 221 are joined to form a transmission mechanism housing portion 90 housing transmission mechanism 208.

Deceleration mechanism housing portion 211 includes an outer race housing portion 213 housing an outer race portion 111 of a ball bearing 11, and a locknut housing portion 214 housing a locknut 12 used for fixing outer race portion 111.

Ball screw 94 includes cylindrical nut 941 disposed on the outer peripheral side of rack bar 204, a ball circulation groove 942 provided between nut 941 and rack bar 204, a plurality of rollable balls 943 provided inside ball circulation groove 942, and a tube 944 connecting both ends of ball circulation groove 942 for circulation of balls 943.

Nut 941 is formed in a cylindrical shape surrounding rack bar 204, and is provided to be relatively rotatable to rack bar 204.

Ball circulation groove 942 includes a shaft-side ball screw groove 942a provided on the outer peripheral side of the rack bar 204 and having a spiral groove shape, and a nut-side ball screw groove 942b provided on the inner peripheral side of nut 941 and having a spiral groove shape.

Nut 941 is rotatably supported through ball bearing 11 housed in outer race housing portion 213 of deceleration mechanism housing portion 211.

Ball bearing 11 is attached and fixed to outer race housing portion 213 by locknut 12 housed in locknut housing portion 214.

More specifically, ball bearing 11 includes outer race portion 111 fixed to outer race housing portion 213 by locknut 12, an inner race portion 112 disposed to face an inner peripheral side of outer race portion 111 and provided integrally with nut 941, and a plurality of rollable balls 113 housed between outer race portion 111 and inner race portion 112.

Locknut 12 is fixed to deceleration mechanism housing portion 211 by screwing a male screw portion provided on an outer periphery of locknut 12, to a female screw portion 215 provided on locknut housing portion 214.

At this time, outer race portion 111 is fixed so as to be sandwiched between first housing 21 and locknut 12 in the axis direction of rack bar 204.

A wave washer 13 is interposed between outer race portion 111 and first housing 21 facing each other in the axial direction of rack bar 204, and between outer race portion 111 and locknut 12 facing each other in the axial direction of rack bar 204.

Looseness of locknut 12 is reduced by urging force of wave washers 13.

As described above, microcomputer 230A of control device 230 has a function of controlling the output torque of motor 220 in order to assist steering force of the driver or to perform autonomous steering.

Microcomputer 230A of control device 230 further has a function of controlling the output torque of motor 220 to buffer motion of rack bar 204 in order to reduce impact when any of rack ends 204A abuts on corresponding stopper portion 205A of rack housing 205, that is, when movement of rack bar 204 is mechanically limited.

In the following, damping control of buffering motion of rack bar 204 when any of the rack ends 204A abuts on corresponding stopper portion 205A of rack housing 205 is described in detail.

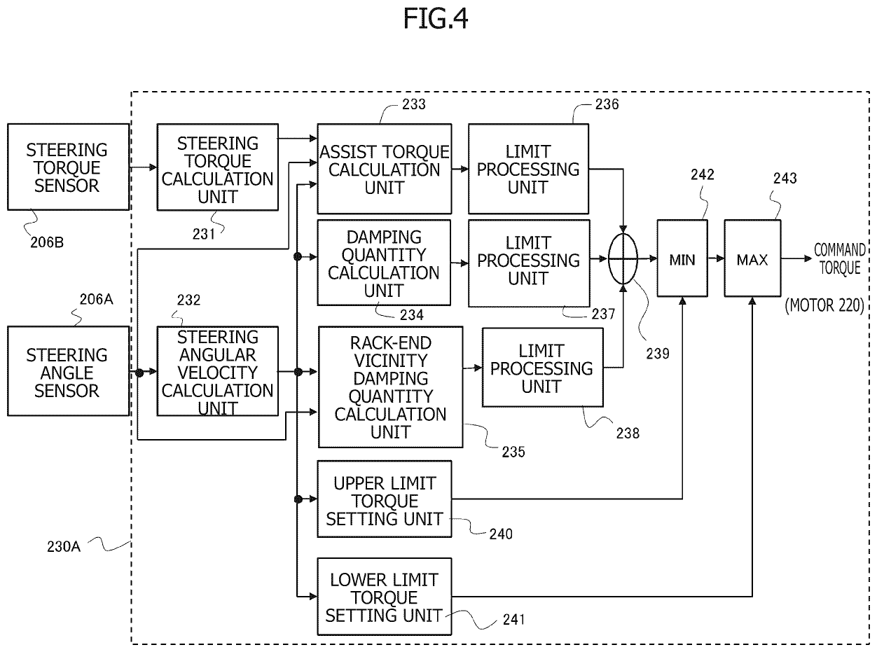

FIG. 4 is a functional block diagram illustrating setting control of the command torque of motor 220 performed by microcomputer 230A, and illustrates a case of controlling the output torque of motor 220 in order to assist steering force of the driver.

A steering torque calculation unit 231 calculates the steering torque TS based on the signal output from steering torque sensor 206B.

A steering angular velocity calculation unit 232 calculates a steering angular velocity Δβ [dps (degree per second)] equivalent to a moving speed of rack bar 204 based on the signal of the steering angle β output from steering angle sensor 206A.

In steering mechanism 210 of electric power steering apparatus 200, steering wheel 201 and rack bar 204 are mechanically coupled to each other, and rack bar 204 is moved in a right-left direction of vehicle 100 in conjunction with rotation of steering wheel 201.

Therefore, the moving speed of rack bar 204 can be estimated from change in steering angle β of steering wheel 201.

Note that the steering angular velocity Δβ distinguishes and indicates whether the moving direction of rack bar 204 is a direction toward a left side or a direction toward a right side in a width direction of vehicle 100, by a positive sign or a negative sign.

An assist torque calculation unit 233 calculates assist torque that is motor torque applied to assist steering force of the driver, based on respective signals of the steering torque TS, the steering angle β, and the steering angular velocity Δβ.

The assist torque calculated by assist torque calculation unit 233 distinguishes and indicates a torque application direction by positive and negative signs.

A damping quantity calculation unit 234 calculates a damping quantity to suppress meandering of vehicle 100 due to excessive return of steering wheel 201 when steering wheel 201 is returned to the neutral position, based on the steering angular velocity Δβ.

A rack-end vicinity damping quantity calculation unit 235 is a functional unit calculating a damping quantity for reducing impact caused by abutment of the stopper.

Rack-end vicinity damping quantity calculation unit 235 acquires information on the steering angle β and the steering angular velocity Δβ.

Furthermore, when an absolute value of the steering angle β is greater than or equal to a predetermined steering angle β1, and steering wheel 201 is operated in a turning direction, rack-end vicinity damping quantity calculation unit 235 calculates the damping quantity that is an attenuation force against steering force of motor 220 in the turning direction so as to increase as the steering angular velocity Δβ increases.

Note that operation of steering wheel 201 in the turning direction indicates operation in a further-turning direction, or in a direction separating from the neutral position, or in a direction in which the absolute value of the steering angle β is increased.

The condition “absolute value of steering angle β is greater than or equal to predetermined steering angle β1 and steering wheel 201 is operated in turning direction” is a condition for determining whether any of rack ends 204A is at a position immediately before abutting on corresponding stopper portion 205A.

In other words, the damping quantity calculated by rack-end vicinity damping quantity calculation unit 235 is a control signal for performing damping control of buffering motion of rack bar 204 immediately before any of rack ends 204A of rack bar 204 abuts on corresponding stopper portion 205A of rack housing 205.

Rack-end vicinity damping quantity calculation unit 235 calculates the damping quantity by proportion, integration, and differential operation based on, for example, deviation between the steering angular velocity Δβ and a target value for each steering angle β.

In other words, rack-end vicinity damping quantity calculation unit 235 targets the moving speed of rack bar 204 causing allowable impact force at abutment of stopper, and sets the damping quantity correcting the torque of motor 220 in order to realize such a target moving speed.

Rack-end vicinity damping quantity calculation unit 235 can variably set the predetermined steering angle β1 as a control starting condition, based on the steering angular velocity Δβ.

In detail, rack-end vicinity damping quantity calculation unit 235 can change the absolute value of the predetermined steering angle β1 to a smaller value as an absolute value of the steering angular velocity Δβ increases such that the damping control is started from the steering angle β having a smaller absolute value as the absolute value of the steering angular velocity Δβ increases.

Limit processing units 236 to 238 perform limit processing to maintain or reduce the assist torque and the damping quantities calculated by assist torque calculation unit 233, damping quantity calculation unit 234, and rack-end vicinity damping quantity calculation unit 235.

For example, limit processing unit 236 is a functional unit performing limit processing for limiting the assist torque calculated by assist torque calculation unit 233 to an upper limit value or less, and changes the upper limit value of the assist torque to a smaller value as the steering angle β approaches the maximum steering angle β at the stopper abutment position.

An addition unit 239 determines the command torque of motor 220 based on the assist torque and the damping quantities subjected to the limit processing by limit processing units 236 to 238, and outputs the command torque.

A signal of the command torque output from addition unit 239 includes the damping quantity calculated by rack-end vicinity damping quantity calculation unit 235 as described above. Therefore, when motor 220 actually outputs the command torque, it is possible to suppress impact force at abutment of the stopper, and to prevent locknut 12 from being loosened due to excessive impact force.

In a state in which a rotation number [rpm] of motor 220 is high, however, motor 220 cannot output actual torque comparable to the command torque, any of rack ends 204A abut on corresponding stopper portion 205A at excessively high speed, and excessive impact force may be applied to locknut 12.

In other words, motor 220 as the DC motor has limit characteristics (T-N characteristics) in which the torque is reduced with increase in rotation number N, and the torque that can be generated by motor 220 is reduced as the rotation number N is increased.

Therefore, even if an attempt is made to generate required torque by rack-end vicinity damping quantity calculation unit 235, only a torque less than the required torque is generatable when such required torque exceeds torque generatable at the motor rotation number at that time, that is, exceeds a characteristic limit, and the buffer effect by the damping control in the vicinity of the rack end is reduced.

Therefore, microcomputer 230A has a functional unit that suppresses the moving speed of rack bar 204, that is, the motor rotation number by limiting the command torque output from addition unit 239, by torque limit value based on the steering angular velocity Δβ (i.e., moving speed of rack bar 204).

Microcomputer 230A suppresses the required torque by the damping control to the motor rotation number that can actually be output by the torque limit processing based on such a steering angular velocity Δβ before the damping control by rack-end vicinity damping quantity calculation unit 235 starts, thereby making the damping control in the vicinity of the rack end work effectively.

More specifically, microcomputer 230A includes functional units of an upper limit torque setting unit 240, a lower limit torque setting unit 241, a selection-low processing unit 242, and a selection-high processing unit 243.

Upper limit torque setting unit 240 sets an upper limit value Tmax of the command torque of motor 220 based on the steering angular velocity Δβ.

Selection-low processing unit 242 acquires the command torque output from addition unit 239, and the upper limit value Tmax set by upper limit torque setting unit 240.

When the command torque output from addition unit 239 is less than or equal to the upper limit value Tmax, selection-low processing unit 242 outputs the command torque output from addition unit 239 as it is.

When the command torque output from addition unit 239 is greater than the upper limit value Tmax, selection-low processing unit 242 outputs the upper limit value Tmax as the command torque.

In other words, selection-low processing unit 242 limits the command torque determined by addition unit 239 to the upper limit value Tmax or less.

On the other hand, lower limit torque setting unit 241 sets a lower limit value Tmin of the command torque of motor 220 based on the steering angular velocity Δβ.

Selection-high processing unit 243 acquires the command torque after the limit processing by selection-low processing unit 242, and the lower limit value Tmin set by lower limit torque setting unit 241.

When the command torque output from selection-low processing unit 242 is greater than or equal to the lower limit value Tmin, selection-high processing unit 243 outputs the command torque output from selection-low processing unit 242 as it is.

When the command torque output from selection-low processing unit 242 is less than the lower limit value Tmin, selection-high processing unit 243 outputs the lower limit value Tmin as the command torque.

In other words, selection-high processing unit 243 limits the command torque after the limit processing by selection-low processing unit 242, i.e., the command torque limited to be less than or equal to the upper limit value Tmax, to be greater than or equal to the lower limit value Tmin.

Therefore, when the command torque output from addition unit 239 is less than or equal to the upper limit value Tmax and greater than or equal to the lower limit value Tmin, the command torque output from addition unit 239 is output from selection-high processing unit 243 as it is.

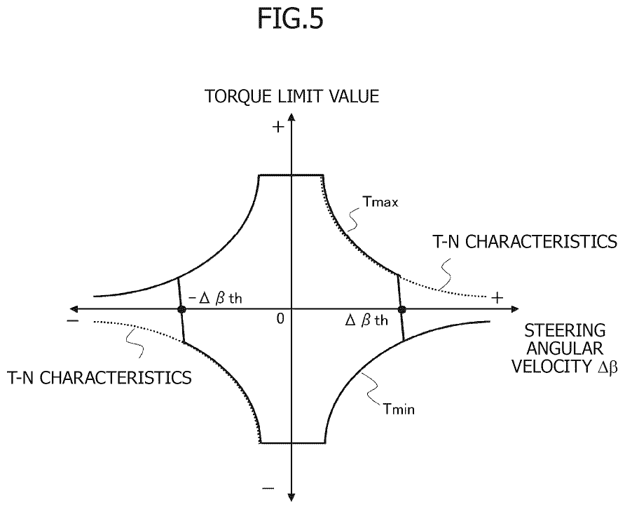

FIG. 5 illustrates an aspect of correlation between the steering angular velocity Δβ and the upper limit value Tmax/lower limit value Tmin.

A lateral axis in FIG. 5 indicates the steering angular velocity Δβ [dps], and a vertical axis in FIG. 5 indicates the upper/lower limit values [Nm] of the command torque.

The upper limit value Tmax and the lower limit value Tmin are basically set to characteristics corresponding to the T-N characteristics of motor 220. The maximum torque in the positive direction that can be generated for each steering angular velocity Δβ is the upper limit value Tmax, and the maximum torque in the negative direction that can be generated for each steering angular velocity Δβ is the lower limit value Tmin.

However, setting is performed such that, when the steering angular velocity Δβ becomes greater than a threshold Δβth in a first quadrant indicating the torque in a direction assisting movement of rack bar 204 in the positive direction, the upper limit value Tmax is switched to the maximum torque acting in a direction opposite to the moving direction of rack bar 204 illustrated in a fourth quadrant.

Therefore, when rack bar 204 is moved in the positive direction, in a region where the steering angular velocity Δβ is higher than the threshold Δβth, the upper limit value Tmax is equal to the lower limit value Tmin, and the upper limit value Tmax and the lower limit value Tmin are the maximum torque acting in the direction opposite to the moving direction of rack bar 204.

Similarly, setting is performed such that, when the absolute value of the steering angular velocity Δβ exceeds the threshold Δβth in a third quadrant indicating the torque in a direction assisting movement of rack bar 204 in the negative direction, the lower limit value Tmin is switched to the maximum torque acting in a direction opposite to the moving direction of rack bar 204 illustrated in a second quadrant.

Therefore, when rack bar 204 is moved in the negative direction, in a region in which the absolute value of the steering angular velocity Δβ is greater than the threshold Δβth, the upper limit value Tmax is equal to the lower limit value Tmin, and the upper limit value Tmax and the lower limit value Tmin are the maximum torque acting in the direction opposite to the moving direction of rack bar 204.

For example, when the steering angular velocity Δβ exceeds the threshold Δβth while the steering angular velocity Δβ has a positive value, the torque of motor 220 has a positive value, and the motor torque assisting movement of rack bar 204 in one direction is applied, the upper limit value Tmax is switched from the positive value to the negative value, and the negative upper limit value Tmax is accordingly output as the command torque from selection-low processing unit 242.

As a result, motor 220 outputs the maximum torque that is torque acting in the direction opposite to the moving direction of rack bar 204 and generatable at the motor rotation speed at that time.

Accordingly, control is switched from the control of assisting movement of rack bar 204 to control of decelerating movement of rack bar 204 at the maximum, and the steering angular velocity Δβ is controlled to be less than or equal to the threshold Δβth.

Note that, in a case in which the steering angular velocity Δβ exceeds the threshold Δβth while the steering angular velocity Δβ has a positive value, the upper limit value Tmax and the lower limit value Tmin are set to negative values, and the upper limit value Tmax is equal to the lower limit value Tmin.

Therefore, selection-high processing unit 243 outputs the command torque output from selection-low processing unit 242, that is, the negative upper limit value Tmax as it is.

In contrast, when the absolute value of the steering angular velocity Δβ exceeds the threshold Δβth while the steering angular velocity Δβ has a negative value, the torque of motor 220 has a negative value, and the motor torque assisting movement of rack bar 204 in the other direction is applied, the lower limit value Tmin is switched from the negative value to the positive value, and the positive lower limit value Tmin is accordingly output as the command torque from selection-high processing unit 243.

As a result, motor 220 outputs the maximum torque that is torque acting in the direction opposite to the moving direction of rack bar 204 and generatable at the motor rotation speed at that time.

Accordingly, the control is switched from the control of assisting movement of rack bar 204 to the control of decelerating movement of rack bar 204 at the maximum, and the steering angular velocity Δβ is controlled to be less than or equal to the threshold Δβth.

Note that, in a case in which the absolute value of the steering angular velocity Δβ exceeds the threshold Δβth while the steering angular velocity Δβ has a negative value, the upper limit value Tmax and the lower limit value Tmin are set to positive values, and the upper limit value Tmax is equal to the lower limit value Tmin.

Therefore, selection-low processing unit 242 outputs the negative command torque output from addition unit 239 as it is, and selection-high processing unit 243 outputs the positive lower limit value Tmin as the command torque.

In the following, functional effects achieved by the command torque limitation processing corresponding to the steering angular velocity Δβ performed by upper limit torque setting unit 240, lower limit torque setting unit 241, selection-low processing unit 242, and selection-high processing unit 243 are described.

As described above, rack-end vicinity damping quantity calculation unit 235 adds the damping quantity for reducing impact caused by abutment of the stopper, to the command torque when any of rack ends 204A approach within a predetermined range from corresponding stopper portion 205A of rack housing 205.

However, motor 220 as the DC motor has characteristics in which the torque is reduced as the rotation speed [rpm] is increased.

Therefore, when the steering angular velocity Δβ, in other words, the moving speed of rack bar 204 is increased and the motor rotation speed is increased, the command torque by the damping control in the vicinity of the rack end that is the motor torque necessary for reducing impact caused by abutment of the stopper cannot be generated in some cases.

If impact caused by abutment of the stopper cannot be sufficiently reduced, for example, locknut 12 is loosened due to a large load applied to locknut 12, and movement of steering mechanism 210 is hindered, which may deteriorate steering performance.

In contrast, the command torque limitation processing corresponding to the steering angular velocity Δβ controls the command torque such that the steering angular velocity Δβ becomes less than or equal to the threshold Δβth before the damping quantity by rack-end vicinity damping quantity calculation unit 235 is added.

In other words, the command torque limitation processing corresponding to the steering angular velocity Δβ is processing for outputting a control signal to suppress the speed of rack bar 204 when the moving speed of rack bar 204 as the movable member satisfies a predetermined condition (|Δβ|>Δβth) and before the damping control in the vicinity of the rack end is performed.

When the command torque limitation processing corresponding to the steering angular velocity Δβ is performed, the damping quantity by rack-end vicinity damping quantity calculation unit 235 can be added under the condition that the steering angular velocity Δβ is less than or equal to the threshold Δβth.

Thus, the threshold Δβth is set based on the maximum steering angular velocity Δβ (i.e., maximum motor rotation speed) that can generate the motor torque assumed to be necessary for reducing impact caused by abutment of the stopper.

As a result, the condition in which the torque required by the damping control of rack-end vicinity damping quantity calculation unit 235 can be generated can be maintained, and an impact reducing effect by the damping control in the vicinity of the rack end can be reliably achieved.

When sufficient impact reduction is achieved, looseness of locknut 12 caused by the impact is suppressed. This makes it possible to maintain movement of steering mechanism 210 in good condition.

In other words, the threshold Δβth is a condition enabling output of the torque of motor 220 necessary for suppressing the moving speed of rack bar 204. When the steering angular velocity Δβ is controlled to be less than or equal to the threshold Δβth, the torque necessary for suppressing the moving speed of rack bar 204 can actually be generated.

Note that the threshold Δβth is preferably a value based on the torque-rotation number characteristics of motor 220 and is preferably adapted as a condition not causing discomfort for the driver. The threshold Δβth is, for example, a value of about 1200 [dps].

In the command torque limitation processing based on the upper and lower limit values Tmax and Tmin, the steering angular velocity Δβ that is an operation speed of steering wheel 201 is used as a physical quantity relating to the moving speed of rack bar 204.

Electric power steering apparatus 200 (steering mechanism) 210 is operated through operation of steering wheel 201 by the driver. Therefore, when the command torque limitation processing is performed based on the steering angular velocity Δβ the moving speed of rack bar 204 can be suppressed with high responsiveness.

Accordingly, for example, even in a case in which steering wheel 201 is abruptly operated to suddenly direct the vehicle body in an opposite direction while vehicle 100 travels straight, it is possible to reliably reduce impact caused by abutment of the stopper.

### Second Embodiment

The impact reducing control by the combination of rack-end vicinity damping quantity calculation unit 235, upper limit torque setting unit 240, lower limit torque setting unit 241, selection-low processing unit 242, and selection-high processing unit 243 is not limited to the case of assisting the steering force of the driver, and can be performed during automatic driving of vehicle 100.

In a case in which automatic driving (i.e., automatic steering) is performed, control device 230 controls motor 220 based on a command value of a turning angle of each of wheels 110 and 110. Therefore, control device 230 estimates the moving speed of rack bar 204 based on the command value of the turning angle, and limits the command torque of motor 220.

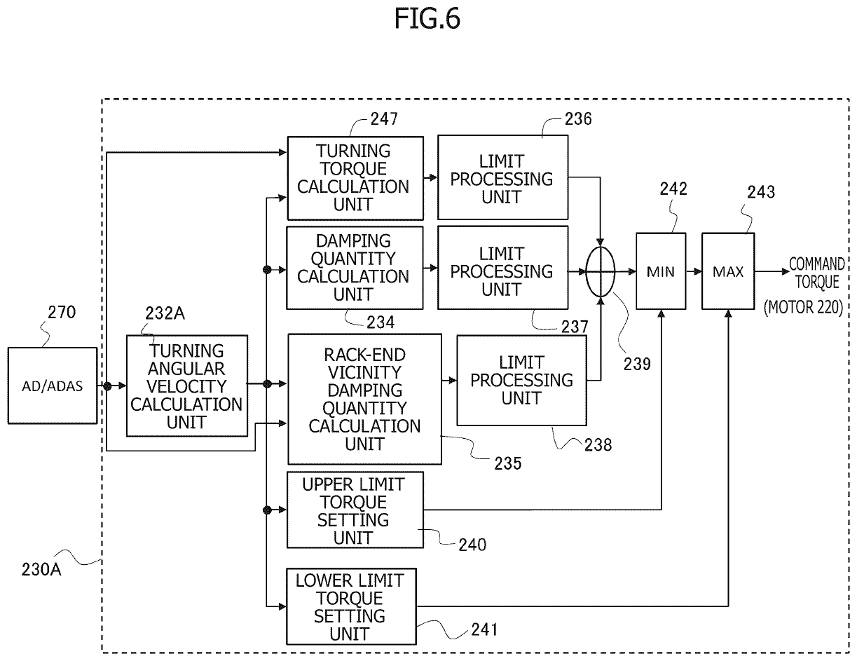

FIG. 6 is a functional block diagram illustrating setting control of the command torque of motor 220 performed by microcomputer 230A, and illustrates a case of controlling turning torque output from motor 220 in order to make an actual turning angle δ of each of wheels 110 and 110 a target turning angle δtg during automatic driving of vehicle 100.

An AD/ADAS control device 270 illustrated in FIG. 6 calculates the target turning angle δtg that is a target value of the turning angle δ of each of the wheels 110 and 110 in an automatic driving and advanced driver assistance system, and outputs a signal of the target turning angle δtg as a command signal to microcomputer 230A of control device 230.

A turning angular velocity calculation unit 232A calculates a time differential value of the target turning angle δtg as a turning angular velocity Δδtg correlating with the moving speed of rack bar 204.

A turning torque calculation unit 247 compares the target turning angle δtg and an actual turning angle δac, and calculates turning torque for bringing the actual turning angle δac close to the target turning angle Stg.

Note that microcomputer 230A can determine the actual turning angle δac from a rotation position of motor 220 detected by motor rotation angle sensor 209.

In a case in which vehicle 100 includes a sensor detecting a position of rack bar 204, microcomputer 230A can determine the actual turning angle δac from a detection result of the position of rack bar 204.

Damping quantity calculation unit 234, rack-end vicinity damping quantity calculation unit 235, upper limit torque setting unit 240, and lower limit torque setting unit 241 calculate the damping quantities and the upper and lower limit values Tmax and Tmin based on the turning angular velocity Δδtg that is the time differential value of the target turning angle Stg.

In other words, control device 230 moves rack bar 204 to a position corresponding to the target turning angle δtg by controlling motor 220 based on the target turning angle Stg. Therefore, the turning angular velocity Δδtg that is the time differential value of the target turning angle δtg is a physical quantity based on the command signal to steering mechanism 210 and a physical quantity relating to the moving speed of rack bar 204 during automatic driving.

As with the characteristics of the upper and lower limit values Tmax and Tmin illustrated in FIG. 5, when an absolute value of the turning angular velocity Δδtg exceeds a threshold Δδth (Δδth>0), upper limit torque setting unit 240 and lower limit torque setting unit 241 respectively switch the upper limit value Tmax and the lower limit value Tmin to the values for deceleration, and control the turning angular velocity Δδtg to be less than or equal to the threshold Δδth.

In other words, when the turning angular velocity Δδtg has a positive value and exceeds the threshold Δδth, upper limit torque setting unit 240 switches the upper limit value Tmax from a positive value to a negative value.

When the turning angular velocity Δδtg has a negative value and an absolute value of the turning angular velocity Δδtg exceeds the threshold Δδth, lower limit torque setting unit 241 switches the lower limit value Tmin from a negative value to a positive value.

As a result, the command torque of motor 220 is set to the maximum torque that is torque acting in a direction opposite to the moving direction of rack bar 204 and generatable at the motor rotation speed at that time.

The threshold Δδth is adapted based on the turning angular velocity Δδtg (i.e., motor rotation speed) that can generate the motor torque necessary for reducing impact caused by abutment of the stopper.

As a result, even during automatic driving of vehicle 100, the deceleration torque commanded by the damping control of rack-end vicinity damping quantity calculation unit 235 can actually be generated, and impact caused by abutment of the stopper can be reduced.

### Third Embodiment

Control device 230 can determine the moving speed of rack bar 204 from the physical quantity relating to the position of rack bar 204, and can set the upper and lower limit values Tmax and Tmin of the command torque based on the determined moving speed of rack bar 204.

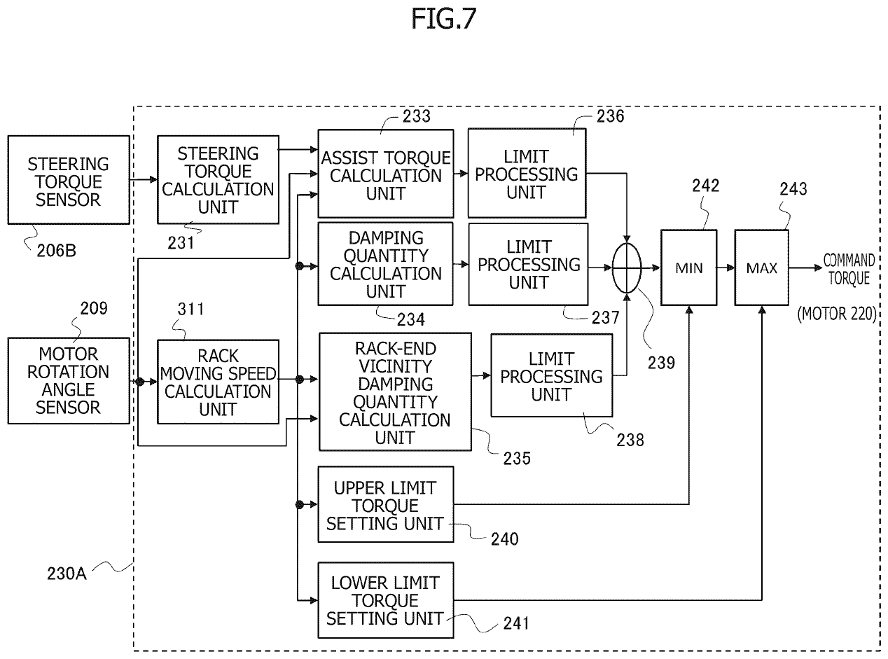

FIG. 7 is a functional block diagram illustrating setting control of the command torque of motor 220 performed by microcomputer 230A, and illustrates a specification in which the upper and lower limit values Tmax and Tmin of the command torque are set based on the moving speed of rack bar 204.

The functional block diagram in FIG. 7 is different from the functional block diagram in FIG. 4 in that a rack moving speed calculation unit 311 is provided in place of steering angular velocity calculation unit 232. In FIG. 7, the elements that are the same as the elements in FIG. 4 are denoted by the same reference numerals, and detailed description of these elements is omitted.

Rack moving speed calculation unit 311 acquires a signal of motor rotation angle sensor 209, and determines a moving speed ΔRP of rack bar 204 from a moving amount of rack bar 204 per unit time.

Note that, in a case in which vehicle 100 includes a rack bar position sensor detecting the position of rack bar 204, rack moving speed calculation unit 311 can determine the moving speed ΔRP of rack bar 204 based on a signal of the rack bar position sensor.

As with the characteristics of the upper and lower limit values Tmax and Tmin illustrated in FIG. 5, when an absolute value of the moving speed ΔRP exceeds a threshold ΔRPth(ΔRPth>0), upper limit torque setting unit 240 and lower limit torque setting unit 241 respectively switch the upper limit value Tmax and the lower limit value Tmin to the values for deceleration, and control the turning angular velocity Δδtg to be less than or equal to the threshold Δδth.

In other words, when the moving speed ΔRP has a positive value and exceeds the threshold ΔRPth, upper limit torque setting unit 240 switches the upper limit value Tmax from a positive value to a negative value.

When the moving speed ΔRP has a negative value and an absolute value of the moving speed ΔRP exceeds the threshold Δ RPth, lower limit torque setting unit 241 switches the lower limit value Tmin from a negative value to a positive value.

As a result, the command torque of motor 220 is set to the maximum torque that is torque acting in a direction opposite to the moving direction of rack bar 204 and generatable at the motor rotation speed at that time.

The threshold ΔRPth is adapted as the moving speed ΔRP (i.e., motor rotation speed) that can generate the motor torque necessary for reducing impact caused by abutment of the stopper. Therefore, before the damping control in the vicinity of the rack end is performed, the motor rotation speed can be controlled to the motor rotation speed that can actually generate the command torque by the damping control, and effectiveness of the damping control can be maintained.

Furthermore, the upper and lower limit values Tmax and Tmin of the command torque are set based on the moving speed ΔRP of rack bar 204. Therefore, in a case in which the moving speed of rack bar 204 is increased due to disturbance or external force applied via wheels 110 and 110, the motor torque that suppresses the moving speed of rack bar 204 with high response can be generated.

Thus, even in the case in which the moving speed of rack bar 204 is increased due to disturbance or external force, it is possible to reliably maintain a moving speed that can generate the motor torque necessary for reducing impact caused by abutment of the stopper.

To calculate the assist torque, microcomputer 230A can use the steering angular velocity Δβ indicating the operation speed of steering wheel 201. To calculate the damping quantity, microcomputer 230A can use the moving speed ΔRP of rack bar 204.

Furthermore, microcomputer 230A can perform damping control based on the moving speed ΔRP of rack bar 204 during automatic driving.

### Fourth Embodiment

The damping control by the combination of rack-end vicinity damping quantity calculation unit 235, upper limit torque setting unit 240, lower limit torque setting unit 241, selection-low processing unit 242, and selection-high processing unit 243 is applicable to a steer-by-wire steering system not including a mechanical coupling between steering wheel 201 and wheels 110 and 110.

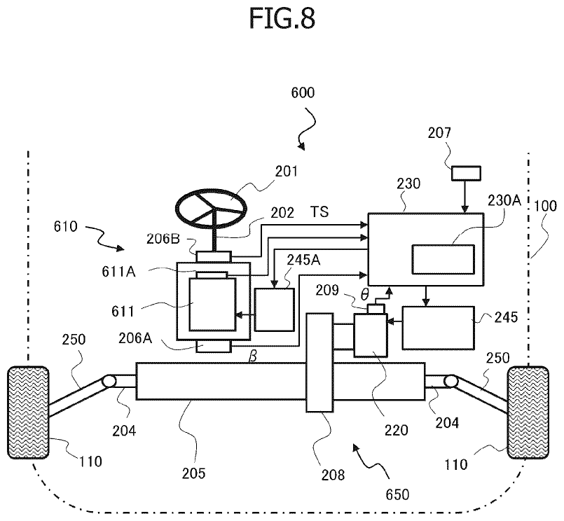

FIG. 8 is a configuration diagram illustrating an aspect of a steer-by-wire steering system 600.

In FIG. 8, the elements that are the same as the elements in FIG. 1 are denoted by the same reference numerals, and detailed description of these elements is omitted.

Steer-by-wire steering system 600 includes a steering input device 610 including steering wheel 201 and a motor 611 functioning as a reaction force actuator, a turning device 650 including rack bar 204, transmission mechanism 208, and motor 220 as a turning actuator, and control device 230 controlling motor 611 and motor 220.

Steering input device 610 includes steering wheel 201, steering shaft 202, motor 611, steering angle sensor 206A, and steering torque sensor 206B.

Steering shaft 202 is rotated in conjunction with rotation of steering wheel 201, but it is mechanically separate from wheels 110 and 110.

Motor 611 is an actuator that can apply steering reaction force to steering wheel 201, and includes a motor rotation angle sensor 611A, a (not shown) torque damper, a decelerator, and a stopper mechanism described in detail below, and the like.

Motor 611 is, for example, a three-phase brushless DC motor.

In steering input device 610, steering wheel 201 is rotated by difference between operation torque generated through operation of steering wheel 201 by the driver and reaction force torque generated by motor 611.

Microcomputer 230A of control device 230 calculates target reaction force torque RTtg and the target turning angle δtg by calculation processing based on information on the steering angle β that is the operation quantity of steering wheel 201, the actual turning angle δac of each of wheels 110 and 110, the vehicle speed, and the like.

Furthermore, microcomputer 230A outputs a switch signal to a driving circuit 245A based on the target reaction force torque RTtg, and performs PWM control of a driving current of motor 611.

In addition, microcomputer 230A compares the target turning angle δtg and the actual turning angle δac to determine the turning torque for bringing the actual turning angle δac close to the target turning angle Stg, outputs a switch signal to driving circuit 245 based on the turning torque as the command torque, and performs PWM control of the driving current of motor 220.

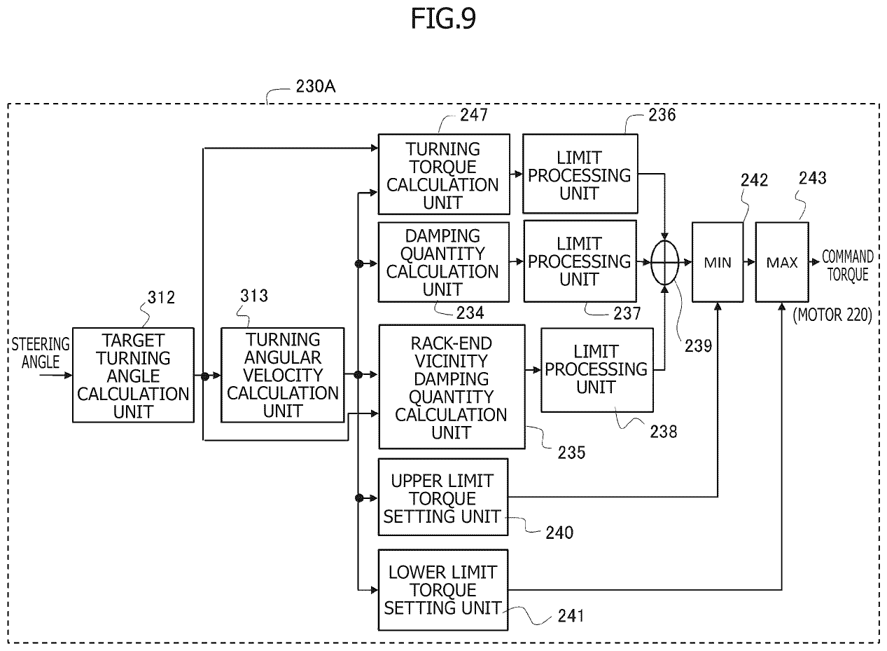

FIG. 9 is a functional block diagram illustrating setting control of the command torque of motor 220 performed by microcomputer 230A.

In FIG. 9, the elements that are the same as the elements in the functional block diagram in FIG. 6 described in the second embodiment are denoted by the same reference numerals, and detailed description of these elements is omitted.

A target turning angle calculation unit 312 calculates the target turning angle δtg of each of wheels 110 and 110 from the steering angle β that is the operation quantity of steering wheel 201. Turning torque calculation unit 247 compares the target turning angle δtg and the actual turning angle Sac, and calculates the turning torque for bringing the actual turning angle δac close to the target turning angle δtg.

On the other hand, a turning angular velocity calculation unit 313 calculates the turning angular velocity Δδtg that is a time differential value of the target turning angle δtg calculated by target turning angle calculation unit 312, as a physical quantity correlating with the moving speed of rack bar 204.

Thereafter, rack-end vicinity damping quantity calculation unit 235, upper limit torque setting unit 240, lower limit torque setting unit 241, selection-low processing unit 242, and selection-high processing unit 243 perform calculation of the damping quantity and the limit processing of the command torque based on the turning angular velocity Δδtg.

As a result, even in the steer-by-wire steering system 600, before the damping control by rack-end vicinity damping quantity calculation unit 235 is performed, the condition that the motor torque necessary for reducing impact caused by abutment of the stopper can be generated and be realized.

This makes it possible to reliably maintain effectiveness of the damping control by rack-end vicinity damping quantity calculation unit 235.

Note that, as described in the third embodiment, rack moving speed calculation unit 311 can be provided in place of turning angular velocity calculation unit 313, and calculation of the damping quantity by rack-end vicinity damping quantity calculation unit 235 and calculation of the upper and lower limit values by upper limit torque setting unit 240 and lower limit torque setting unit 241 can be performed based on a detected value of the moving speed ΔRP of rack bar 204 that is the time differential value of a positional signal RP of rack bar 204.

### Fifth Embodiment

In a case in which, in a steer-by-wire steering system 600 illustrated in FIG. 8, steering shaft 202 is rotated by motor 611 in order to move steering wheel 201 to a rotation position corresponding to a command in the automatic driving, the damping control can be applied to the command torque of motor 611.

Here, steering shaft 202 is a movable member relating to steering, and motor 611 is a motor applying torque to the movable member.

As described in detail below, steer-by-wire steering system 600 includes a stopper mechanism limiting a rotation range of steering shaft 202.

Therefore, microcomputer 230A performs the damping control of buffering rotation of steering shaft 202 immediately before the stopper mechanism of steering shaft 202 abuts, and it outputs a control signal for suppressing the rotation speed of steering shaft 202 before the damping control is performed immediately before abutment of the stopper.

As a result, when the damping control is performed immediately before abutment of the stopper, the condition in which the torque necessary for the damping control can be output can be realized, and effectiveness of the damping control can be maintained.

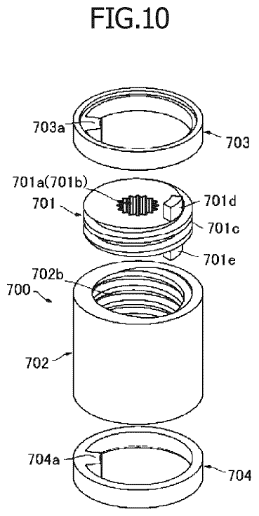

FIG. 10 is a perspective view illustrating an aspect of a stopper mechanism 700 that limits the rotation range of steering shaft 202 in steer-by-wire steering system 600.

A disk-like spline boss member 701 includes teeth 701b on an inner periphery of a spline hole 701a provided at an axial center.

When teeth provided on an outer periphery of steering shaft 202 is fitted to teeth 701b of spline boss member 701, rotational force of steering shaft 202 is transmitted to spline boss member 701.

A male screw 701c is provided on an outer peripheral edge of spline boss member 701.

In addition, protrusions 701d and 701e protruding in an axial direction are provided at predetermined angle positions near an outer periphery on respective end surfaces of spline boss member 701 in the axial direction.

A cylindrical member 702 fixed to the vehicle body includes, on an inner peripheral surface, a female screw 702b engaging with male screw 701c of spline boss member 701.

By such a structure, spline boss member 701 advances and retreats in the axial direction inside cylindrical member 702 while rotating around the axis with rotating motion of steering shaft 202.

A first ring member 703 is coaxially coupled to cylindrical member 702 on an upper side of cylindrical member 702.

A first stopper portion 703a protruding toward the axial center is provided at a predetermined angle position on an inner peripheral surface of first ring member 703.

On the other hand, a second ring member 704 is coaxially coupled to cylindrical member 702 on a lower side of cylindrical member 702.

A second stopper portion 704a protruding toward the axial center is provided at a predetermined angle position on an inner peripheral surface of second ring member 704.

When steering shaft 202 rotates in one direction, and spline boss member 701 moves toward first ring member 703 inside cylindrical member 702 while rotating, protrusion 701d of spline boss member 701 abuts on first stopper portion 703a of first ring member 703.

When protrusion 701d of spline boss member 701 abuts on first stopper portion 703a of first ring member 703, and rotation and movement in the axial direction of spline boss member 701 are prevented, steering shaft 202 cannot rotate any further.

Likewise, steering shaft 202 rotates in the other direction, and spline boss member 701 moves toward second ring member 704 inside cylindrical member 702 while rotating, protrusion 701e of spline boss member 701 abuts on second stopper portion 704a of second ring member 704.

When protrusion 701e of spline boss member 701 abuts on second stopper portion 704a of second ring member 704, and rotation and movement in the axial direction of spline boss member 701 are prevented, steering shaft 202 cannot rotate any further.

In other words, stopper mechanism 700 defines a range between the rotation position of steering shaft 202 where protrusion 701d abuts on first stopper portion 703a and the rotation position of steering shaft 202 where protrusion 701e abuts on second stopper portion 704a, as the rotation range of steering shaft 202.

Next, torque control of motor 611 for reducing impact at abutment of stopper mechanism 700 is described.

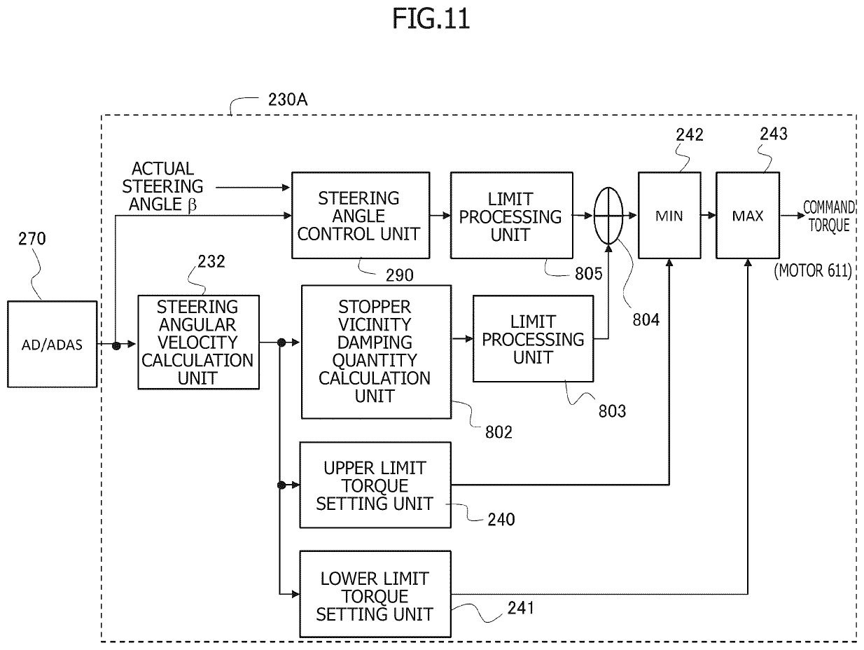

FIG. 11 is a functional block diagram illustrating setting control of the command torque of motor 611 performed by microcomputer 230A, and illustrates a case of controlling the command torque of motor 611 based on a steering angle command of steering wheel 201 during automatic driving of vehicle 100.

AD/ADAS control device 270 illustrated in FIG. 11 calculates a steering angle command βtg that is a rotation position command of steering wheel 201 (steering shaft 202) during automatic driving of vehicle 100 (or advanced driver assistance), and outputs a signal of the steering angle command βtg as a command signal to microcomputer 230A of control device 230.

A steering angle control unit 290 calculates the command torque of motor 611 based on the steering angle command βtg and the actual steering angle β detected by steering angle sensor 206A.

Steering angular velocity calculation unit 232 determines a steering angular velocity Δβtg that is the time differential value of the steering angle command βtg, as a physical quantity relating to the rotation speed of steering shaft 202.

When an absolute value of the steering angle command βtg is greater than or equal to a predetermined steering angle βth1, and the steering angle command βtg is changed in the turning direction of steering wheel 201, a stopper vicinity damping quantity calculation unit 802 calculates the damping quantity for buffering rotation of steering shaft 202 so as to increase as a steering angular velocity Δβth is increased.

In other words, when steering shaft 202 is rotationally driven by the torque of motor 611 based on the steering angle command βtg, stopper vicinity damping quantity calculation unit 802 sets the damping quantity for decelerating the rotation of steering shaft 202 immediately before abutment of stopper mechanism 700, in order to buffer impact at abutment.

As a result, when steering shaft 202 is rotated based on the steering angle command βtg, stopper vicinity damping quantity calculation unit 802 decelerates the rotation of steering shaft 202 by the damping control immediately before abutment of the stopper, and reduces impact at abutment of the stopper.

A limit processing unit 803 performs processing for limiting the damping quantity determined by stopper vicinity damping quantity calculation unit 802.

Thereafter, an addition unit 804 determines the command torque of motor 611 based on the damping quantity output from limit processing unit 803 and the command torque output from steering angle control unit 290.

On the other hand, upper limit torque setting unit 240 and lower limit torque setting unit 241 respectively set the upper limit value Tmax and the lower limit value Tmin based on the steering angular velocity Δβtg, as with the characteristics illustrated in FIG. 5 described above.

Selection-low processing unit 242 and selection-high processing unit 243 limit the command torque to a value between the upper limit value Tmax and the lower limit value Tmin based on the upper limit value Tmax and the lower limit value Tmin.

For example, when the steering angular velocity Δβtg exceeds the threshold Δβtgth while the steering angular velocity Δβtg has a positive value, the torque of motor 220 has a positive value, and steering shaft 202 is rotated in one direction by the motor torque, the upper limit value Tmax is switched from a positive value to a negative value, and the negative upper limit value Tmax is accordingly output as the command torque from selection-low processing unit 242.

As a result, motor 611 outputs the maximum torque that is torque acting in the direction opposite to the rotation direction of steering shaft 202 and generatable at the motor rotation speed at that time.

Accordingly, even when the steering angle command βtg causing the steering angular velocity Δβtg that exceeds the threshold Δβtgth is provided, control of decelerating the rotation of the steering shaft 202 at the maximum is performed, and the steering angular velocity Δβtg is controlled to be less than or equal to the threshold Δβtgth.

This makes it possible to realize the motor rotation speed at which the motor torque required by the damping control can be generated, before the damping control by stopper vicinity damping quantity calculation unit 802 is performed.

Thus, when the steering angle command βtg is provided during automatic driving, impact at abutment of stopper mechanism 700 can be reliably buffered by the damping control of stopper vicinity damping quantity calculation unit 802, and stopper mechanism 700 can be protected from the impact.

### Sixth Embodiment

In the setting control of the command torque illustrated in the functional block diagram in FIG. 11, the damping control of the output torque of motor 611 is performed based on the steering angle command βtg that is the rotation position command of steering wheel 201 (steering shaft 202) during automatic driving. Alternatively, the damping control can be performed based on the steering angle β of steering shaft 202 detected by steering angle sensor 206A.

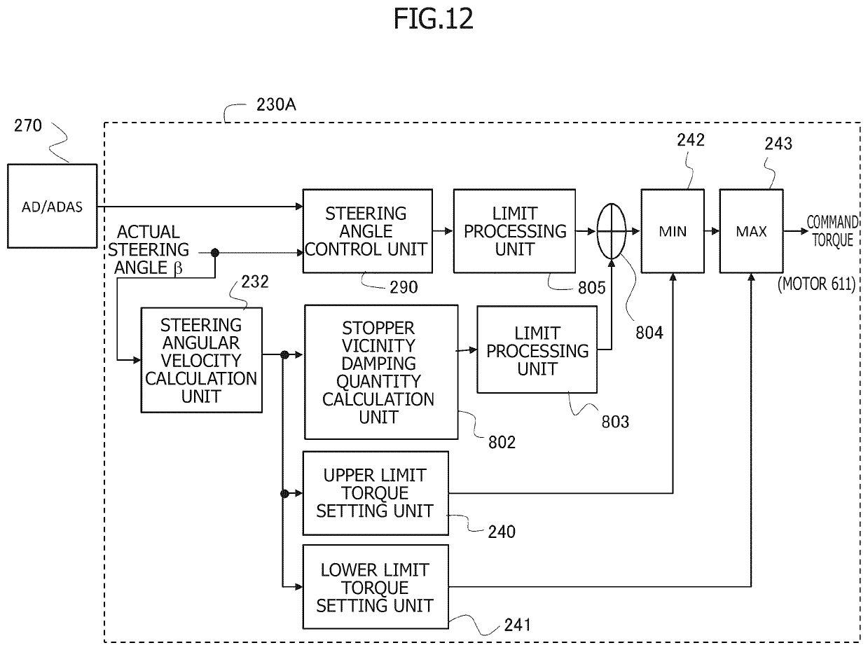

FIG. 12 is a functional block diagram illustrating setting control of the command torque of motor 611 in a case in which the damping control is performed based on the steering angle β.

In FIG. 12, the functional units other than steering angular velocity calculation unit 232 have functions similar to the functional units illustrated in FIG. 11. Therefore, detailed description of such functional units is omitted.

In FIG. 12, steering angular velocity calculation unit 232 calculates the steering angular velocity Δβ equivalent to the rotation speed of steering shaft 202, based on the steering angle β of steering shaft 202 detected by steering angle sensor 206A.

Thereafter, stopper vicinity damping quantity calculation unit 802, upper torque setting unit 240, and lower limit torque setting unit 241 acquire a signal of the steering angular velocity Δβ and set the damping quantity and the upper and lower limit values.

For example, when steering shaft 202 is rotated by rotational driving force of motor 611 during automatic driving, the driver operates steering wheel 201 in a direction that is the same as the rotation direction by the torque of motor 611, and the rotation speed of steering shaft 202 is accordingly greater than the speed corresponding to the steering angle command βtg in some cases.

At this time, in the damping control based on the steering angular velocity Δβ the damping control is performed based on the actual rotation speed of steering shaft 202, which makes it possible to more reliably reduce impact caused by abutment of the stopper.

The technical ideas described in the above-described embodiments may be appropriately used in combination as long as there is no conflict.

Although the contents of the present invention are specifically described with reference to the preferred embodiments, it is obvious that those skilled in the art can make various modifications based on the basic technical ideas and the teachings of the present invention.

For example, steer-by-wire steering system 600 can include a backup mechanism mechanically coupling steering wheel 201 and wheels 110 and 110 by clutches and the like.

Furthermore, when the upper limit value Tmax or the lower limit value Tmin is switched from a positive value to a negative value or from a negative value to a positive value based on the characteristics illustrated in FIG. 5, the upper limit value Tmax or the lower limit value Tmin can be configured to have hysteresis to the speed change.

### REFERENCE SYMBOL LIST

100 Vehicle
110 Wheel
200 Electric power steering apparatus
201 Steering wheel
204 Rack bar (movable member)
205 Rack housing
210 Steering mechanism
220 Motor
230 Control device
230A Microcomputer (control unit)

1. A control device provided in a vehicle, the vehicle including a steering mechanism mounted on the vehicle, the steering mechanism including a motor and a stopper mechanism, the motor applying torque to a movable member relating to steering, and the stopper mechanism including a stopper portion that can abut on the movable member and limiting a moving range of the movable member, the control device comprising a control unit that outputs, to the motor, a control signal for performing damping control of buffering movement of the movable member immediately before the movable member abuts on the stopper portion,
wherein the control unit acquires a physical quantity relating to a moving speed of the movable member, and when the moving speed satisfies a predetermined condition, outputs a control signal for suppressing a speed of the movable member before the damping control is performed.

2. The control device according to claim 1, wherein the predetermined condition is a condition not exceeding a characteristic limit of the motor.

3. The control device according to claim 2, wherein
the steering mechanism includes a ball screw, a transmission mechanism that transmits rotating motion of the motor to the ball screw, a rack bar connected to the ball screw, a housing that houses at least a part of the rack bar and the ball screw, and a locknut for the ball screw,
the movable member is the rack bar, and
the stopper mechanism limits the moving range of the rack bar in an axial direction by abutment of the rack bar and the housing.

4. The control device according to claim 3, wherein the physical quantity relating to the moving speed is a physical quantity based on an operation quantity of a steering wheel mounted on the vehicle.

5. The control device according to claim 3, wherein the physical quantity relating to the moving speed is a physical quantity based on a moving amount of the rack bar.

6. The control device according to claim 3, wherein the physical quantity relating to the moving speed is a physical quantity based on a command signal to the steering mechanism during automatic driving of the vehicle.

7. The control device according to claim 2, wherein
the steering mechanism includes a reaction force actuator that applies steering reaction force to the steering wheel, and a stopper mechanism that limits a rotation range of a rotary shaft of the steering wheel, and
the movable member is the rotary shaft of the steering wheel.

8. The control device according to claim 7, wherein the physical quantity relating to the moving speed is a physical quantity based on a rotation quantity of the rotary shaft.

9. The control device according to claim 7, wherein the physical quantity relating to the moving speed is a physical quantity based on a command signal to the steering mechanism during automatic driving of the vehicle.

10. A control method performed by a control unit for controlling a motor that applies torque to a movable member relating to steering of a steering mechanism mounted on a vehicle, the steering mechanism including a stopper mechanism, and the stopper mechanism including a stopper portion that can abut on the movable member and limiting a moving range of the movable member, the control method comprising the steps of:
outputting, to the motor, a control signal for performing damping control of buffering movement of the movable member immediately before the movable member abuts on the stopper portion;
acquiring a physical quantity relating to a moving speed of the movable member; and
when the moving speed satisfies a predetermined condition, outputting a control signal for suppressing a speed of the movable member before the damping control is performed.

11. A control system comprising:
a steering mechanism mounted on a vehicle, the steering mechanism including a motor that applies torque to a movable member relating to steering, and a stopper mechanism including a stopper portion that can abut on the movable member and limiting a moving range of the movable member; and
a control device including a control unit that outputs a control signal to the motor, the control unit outputting, to the motor, a control signal for performing damping control of buffering movement of the movable member immediately before the movable member abuts on the stopper portion, acquiring a physical quantity relating to a moving speed of the movable member, and when the moving speed satisfies a predetermined condition, outputting a control signal for suppressing a speed of the movable member before the damping control is performed. A control device, a control method, and a control system according to the present invention perform damping control of buffering movement of a movable member immediately before the movable member abuts on a stopper portion, and when a moving speed of the movable member satisfies a predetermined condition, output a control signal for suppressing a speed of the movable member before the damping control is performed. As a result, in a steering mechanism that includes a motor applying torque to a movable member relating to steering, and a stopper mechanism including a stopper portion that can abut on the movable member and limiting a moving range of the movable member, impact force when the movable member abuts on the stopper portion can be reliably reduced.

1. A control device provided in a vehicle, the vehicle including a steering mechanism mounted on the vehicle, the steering mechanism including a motor and a stopper mechanism, the motor applying torque to a movable member relating to steering, and the stopper mechanism including a stopper portion that can abut on the movable member and limiting a moving range of the movable member, the control device comprising a control unit that outputs, to the motor, a control signal for performing damping control of buffering movement of the movable member immediately before the movable member abuts on the stopper portion,
wherein the control unit acquires a physical quantity relating to a moving speed of the movable member, and when the moving speed satisfies a predetermined condition, outputs a control signal for suppressing a speed of the movable member before the damping control is performed.

2. The control device according to claim 1, wherein the predetermined condition is a condition not exceeding a characteristic limit of the motor.

3. The control device according to claim 2, wherein
the steering mechanism includes a ball screw, a transmission mechanism that transmits rotating motion of the motor to the ball screw, a rack bar connected to the ball screw, a housing that houses at least a part of the rack bar and the ball screw, and a locknut for the ball screw,
the movable member is the rack bar, and
the stopper mechanism limits the moving range of the rack bar in an axial direction by abutment of the rack bar and the housing.

4. The control device according to claim 3, wherein the physical quantity relating to the moving speed is a physical quantity based on an operation quantity of a steering wheel mounted on the vehicle.

5. The control device according to claim 3, wherein the physical quantity relating to the moving speed is a physical quantity based on a moving amount of the rack bar.

6. The control device according to claim 3, wherein the physical quantity relating to the moving speed is a physical quantity based on a command signal to the steering mechanism during automatic driving of the vehicle.

7. The control device according to claim 2, wherein
the steering mechanism includes a reaction force actuator that applies steering reaction force to the steering wheel, and a stopper mechanism that limits a rotation range of a rotary shaft of the steering wheel, and
the movable member is the rotary shaft of the steering wheel.

8. The control device according to claim 7, wherein the physical quantity relating to the moving speed is a physical quantity based on a rotation quantity of the rotary shaft.

9. The control device according to claim 7, wherein the physical quantity relating to the moving speed is a physical quantity based on a command signal to the steering mechanism during automatic driving of the vehicle.

10. A control method performed by a control unit for controlling a motor that applies torque to a movable member relating to steering of a steering mechanism mounted on a vehicle, the steering mechanism including a stopper mechanism, and the stopper mechanism including a stopper portion that can abut on the movable member and limiting a moving range of the movable member, the control method comprising the steps of:
outputting, to the motor, a control signal for performing damping control of buffering movement of the movable member immediately before the movable member abuts on the stopper portion;
acquiring a physical quantity relating to a moving speed of the movable member; and
when the moving speed satisfies a predetermined condition, outputting a control signal for suppressing a speed of the movable member before the damping control is performed.

11. A control system comprising:
a steering mechanism mounted on a vehicle, the steering mechanism including a motor that applies torque to a movable member relating to steering, and a stopper mechanism including a stopper portion that can abut on the movable member and limiting a moving range of the movable member; and
a control device including a control unit that outputs a control signal to the motor, the control unit outputting, to the motor, a control signal for performing damping control of buffering movement of the movable member immediately before the movable member abuts on the stopper portion, acquiring a physical quantity relating to a moving speed of the movable member, and when the moving speed satisfies a predetermined condition, outputting a control signal for suppressing a speed of the movable member before the damping control is performed.
